(19) United States
(12) Patent Application Publication
(10) Pub. No.: US 2008/0024548 A1
(43) Pub. Date: Jan. 31, 2008

(54) Methods and apparatus for purging a substrate during inkjet printing

(75) Inventors: Quanyuan Shang, Saratoga, CA (US); Fan Cheung Sze, San Jose, CA (US); Josef Hoog, Novato, CA (US); Lizhong Sun, San Jose, CA (US); John M. White, Hayward, CA (US)

Correspondence Address: DUGAN & DUGAN, PC, 245 Saw Mill River Road, Suite 309, Hawthorne, NY, 10532, US

(73) Assignee: Applied Materials, Inc., Santa Clara, CA (US)

(21) Appl. No.: 11/494,254

(22) Filed: Jul. 26, 2006

(51) Int. Cl. B41J 2/165

(52) U.S. Cl. 347/25

(57) ABSTRACT

The invention provides an inkjet printing apparatus that includes at least one inkjet print head adapted to dispense fluids onto a substrate and at least one delivery aperture adapted to direct a gas toward the substrate. The apparatus may also include at least one recovery aperture adapted to draw materials away from the substrate and evaporate liquids from the surface of the substrate.

### CROSS-REFERENCE TO RELATED APPLICATIONS

The present application is related to the following commonly-assigned, co-pending U.S. Patent Applications, each of which is hereby incorporated herein by reference in its entirety for all purposes:

U.S. Provisional Patent Application Ser. No. 60/721,624, filed Sep. 25, 2005 and entitled “METHODS AND APPARATUS FOR ADJUSTING PIXEL FILL PROFILES”;

U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING”;

U.S. patent application Ser. No. 11/019,967, filed Dec. 22, 2004 and entitled “APPARATUS AND METHODS OF AN INKJET HEAD SUPPORT HAVING AN INKJET HEAD CAPABLE OF INDEPENDENT LATERAL MOVEMENT” (Attorney Docket No. 9521-1);

U.S. patent application Ser. No. 11/019,929, filed Dec. 22, 2004 and titled “METHODS AND APPARATUS FOR INKJET PRINTING.” (Attorney Docket No. 9521-2);

U.S. patent application Ser. No. 11/019,930, filed Dec. 22, 2004 and entitled “METHODS AND APPARATUS FOR ALIGNING PRINT HEADS” (Attorney Docket No. 9521-3); and

U.S. Provisional Patent Application Ser. No. 60/703,146, filed Jul. 28, 2005 and entitled “METHODS AND APPARATUS FOR SIMULTANEOUS INKJET PRINTING AND DEFECT INSPECTION” (Attorney Docket No. 9521-7/L).

U.S. Provisional Patent Application Ser. No. 60/721,340, filed Sep. 27, 2005 and entitled “INKJET DELIVERY MODULE” (Attorney Docket No. 10145/L/DISPLAY).

### FIELD OF THE INVENTION

The present invention relates generally to inkjet printing systems employed during flat panel display formation, and is more particularly concerned with apparatus and methods for preparing substrates for inkjet printing.

### BACKGROUND

The flat panel display industry has been attempting to employ inkjet printing to manufacture display devices, in particular, color filters. However, efficiently jetting ink into pixel wells for color filters so that the pixel wells are reliably filled in a consistent manner is difficult using conventional inkjet printing techniques. This is particularly true in a high throughput manufacturing production context. Thus, what is needed are methods and apparatus for improving the reliability and consistency with which pixel wells are filed without degrading manufacturing throughput.

### SUMMARY OF THE INVENTION

In certain aspects of the invention, an inkjet printing apparatus includes at least one inkjet print head adapted to dispense fluids onto a substrate and at least one delivery aperture adapted to direct a gas toward the substrate. The apparatus may also include at least one recovery aperture adapted to draw materials away from the substrate and evaporate liquids from the surface of the substrate.

In other aspects of the invention, an inkjet printing apparatus includes one or more inkjet print heads adapted to dispense fluids onto a substrate, a print bridge adapted to support the one or more inkjet print heads, and at least one delivery aperture coupled to the print bridge adjacent the one or more inkjet print heads and adapted to direct a gas toward the substrate. The apparatus may also include at least one recovery aperture coupled to the print bridge adjacent the one or more inkjet print heads and adapted to draw materials away from the substrate and evaporate liquids from a surface of the substrate.

In yet other aspects of the invention, a method of preparing a substrate for inkjet printing includes directing a gas toward the substrate through at least one delivery aperture. The method may also include drawing materials away from the substrate through at least one recovery aperture.

In still other aspects of the invention, a method of inkjet printing includes directing a gas toward a substrate through at least one first aperture coupled to a print bridge and jetting ink onto a substrate via one or more inkjet print heads arranged along a print bridge adjacent the at least one first aperture. The method may also include drawing materials away from the substrate and evaporating liquids from a surface of the substrate through at least one recovery aperture coupled to the print bridge adjacent the one or more inkjet print heads.

Other features and aspects of the present invention will become more fully apparent from the following detailed description, the appended claims and the accompanying drawings.

### BRIEF DESCRIPTION OF THE DRAWINGS

FIG. 1A is a top schematic view of an inkjet printing system according to the present invention.

FIG. 1B is a perspective view of an inkjet printing system according to the present invention.

FIG. 2 depicts a close-up view of an exemplary embodiment of a print head portion of an inkjet printing system according to the present invention.

FIG. 3 is an image of an example matrix of pixel wells.

FIG. 4 depicts an example of a graph of the “X” profile of the ink within the two filled pixel wells taken as a cross-section along the X-X line in FIG. 3.

FIG. 5 depicts an example of a graph of the “Y” profile of the ink within one of the filled pixel wells (and four empty wells) taken as a cross-section along the Y-Y line in FIG. 3.

FIG. 6 is an image depicting the example matrix of FIG. 3 after the methods of the present invention have been applied to adjust the ink in the filled pixels.

FIG. 7 depicts an example of a graph of the adjusted X profile of the ink within the two filled pixel wells taken as a cross-section along the X-X line in FIG. 6.

FIG. 8 depicts an example of a graph of the adjusted Y profile of the ink within one of the filled pixel wells (and four empty wells) taken as a cross-section along the Y-Y line in FIG. 6.

FIG. 9 depicts a continuum of wettability.

FIG. 10A is a side schematic view of an inkjet printing system according to some aspects of the present invention.

FIG. 10B is a bottom schematic view of an inkjet printing system according to some aspects of the present invention.

FIG. 11 is a portion of an inkjet printing system of an alternative embodiment of the present invention.

FIG. 12A is a simplified side schematic view of an inkjet printing system according to some aspects of the invention.

FIG. 12B is a simplified bottom schematic view of an inkjet printing system according to some aspects of the invention.

FIG. 12C is a simplified bottom schematic view of an inkjet printing system according to some aspects of the invention.

FIG. 12D is a simplified bottom schematic view of an inkjet printing system according to some aspects of the invention.

### DETAILED DESCRIPTION

Flat panel display manufacturing may use color filters that include different colored inks printed on a glass (or other material) substrate. The ink may be deposited using an inkjet printer adapted to precisely jet ink and/or other suitable material directly into specific pixel wells defined by a matrix. Due to variations in the amount of solvent and/or contaminants present on the surface of the substrates (e.g., in the pixel wells and/or on the matrix) during printing operations, the deposited ink may spread or otherwise manifest unevenly.

The present invention provides methods and apparatus for preparing a substrate surface for printing such that residual solvent and/or contaminants may be substantially removed from the substrate surface. In some embodiments, the present invention may incorporate apparatus for flowing purge gases (e.g., fresh air, nitrogen, etc.) on the substrate prior to ink jetting. The purge gases may blow or evaporate residual solvent and/or contaminants away from the surface, facilitating uniform ink distribution. In the same or other embodiments, the purge gases may be saturated with solvent such that jetted ink is exposed to substantially uniform levels of solvent on the substrate surface, facilitating uniform ink distribution.

Materials in contact with liquid have an attractive or repulsive response to the liquid. The material's composition, its corresponding surface chemistry, and the chemistry of the liquid determine the interaction with the liquid. This phenomena is termed hydrophilicity (e.g., ink-philicity for liquid ink) and hydrophobicity (e.g., ink-phobicity for liquid ink).

Hydrophilicity, also called hydrophilic, is a characteristic of materials exhibiting an affinity for liquid. Hydrophilic literally means “liquid-loving” and such materials readily adsorb liquids. The surface chemistry allows these materials to be wetted forming a liquid film or coating on their surface. Hydrophilic materials also possess a high surface tension value and have the ability to form bonds with liquid.

Hydrophobicity, also termed hydrophobic, materials possessing this characteristic have the opposite response to liquid interaction compared to hydrophilic materials. Hydrophobic materials (“liquid fearing”) have little or no tendency to adsorb liquids and liquid tends to “bead” on their surfaces (i.e., form discrete droplets). Hydrophobic materials possess low surface tension values and lack active groups in their surface chemistry for formation of bonds with liquid.

Wettability refers to a surface property characteristic for all materials which yields a unique value for different compounds. The surface tension value of a material can be utilized to determine wettability of a material by specific liquids. Through the measurement of the contact angle between a solid surface and a droplet of liquid on the surface, the surface tension for the solid material can be calculated.

Surface tension refers to a force, due to an unbalance in molecular forces, that occurs when two different materials (e.g., a liquid droplet on a solid surface) are brought into contact with each other forming an interface or boundary. The force is due to the tendency for all materials to reduce their surface area in response to the unbalance in molecular forces that occurs at their points of contact. The result of this force will vary for different systems of liquids and solids, which dictates the wettability and contact angle between the drop and surface.

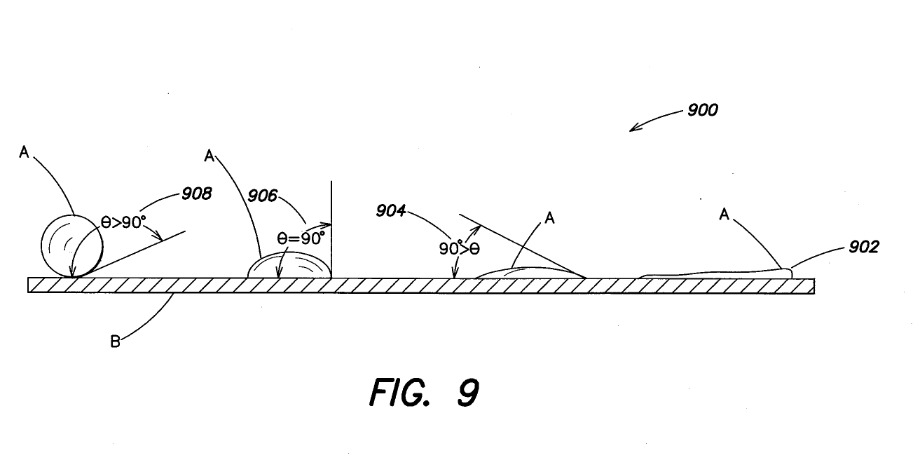

The contact angle of a droplet on a solid surface is a measurement of the angle formed between the surface of the solid and the line tangent to the droplet radius from the point of contact with the solid. The contact angle is related to the surface tension by Young's equation through which the behavior of specific liquid-solid interactions can be calculated. A contact angle of zero degrees results in wetting, while an angle between 0 and 90 degrees results in spreading of the drop (due to molecular attraction). Angles greater than 90 degrees indicate the liquid tends to bead or shrink away from the solid surface (e.g., as will be described in detail below with reference to FIG. 9).

Returning to the present invention, the matrix of pixel wells may be formed on the substrate using lithography or any suitable process. Due to variations in the ink-philicity/ink-phobicity of the substrate and/or the material used to form the matrix, the cross-sectional profile (e.g., the distribution) of the ink drops deposited into the pixel wells may not be optimal for forming color filters. In some cases, the uneven distribution of ink within a pixel well may result in a defect in the color filter. For example, if the ink “beads-up,” it may not fill the pixel wells completely. In another example, if the side walls are ink-philic and a pixel well is not completely filled, a concave (e.g., meniscus) profile may result. The inventors of the present invention have noticed that the ink-philicity/ink-phobicity of the matrix varies significantly among manufactures. Attempts to adjust the surface tension and thus, fill profile of the ink through chemical variations, if even possible, may not be satisfactory.

The present invention further provides methods and apparatus for adjusting the distribution of ink (or other material) within pixel wells, regardless of the ink-philicity/ink-phobicity of the substrate and/or the material used to form the matrix, so that the resulting cross-sectional profile if the deposited ink conforms to a desired shape. For example, a slightly crowned profile or a flat profile may be desired for a color filter application. According to embodiments of the present invention, a stream or curtain of pressurized gas may be used to push ink previously deposited in pixel wells to conform to a desired profile. The pressurized gas may include nitrogen and/or any suitable non-reactive gas. The pressurized gas may be applied immediately after the deposition of the ink or up until the ink cures. In some embodiments, one or more nozzles for directing the pressurized gas may be mounted to a support member that also supports inkjet print heads. As the print heads pass over a substrate depositing ink into pixel wells, the pressurized gas may be directed at the ink just deposited to adjust the profile of the ink.

In alternative or additional embodiments, rather than dynamically applying pressurized gas to the pixel wells as they are filled, the entire substrate may be placed in a chamber within which an overall increased air/gas pressure may be applied to all pixel wells. The increased air/gas pressure acts to adjust the distribution of ink within the pixel wells.

In some embodiments, the substrate, gas, and or ink may additionally be heated to further aid in adjusting the distribution of ink within the pixel wells. Heat may affect the fluidity and/or surface tension of the materials and thus, alter the ink's profile within the pixel wells.

The present invention provides for a number of advantages. For example, the present invention can be utilized to concurrently deposit inks and adjust the profiles of the deposited inks. By adjusting the profile of the deposited inks, the occurrence of defects resulting from uneven distribution of ink may be reduced or eliminated. Further, through timing and the use of different amounts of gas pressure, the amount of force applied to the deposited ink may be controlled to adjust the shape of the ink's profile within the pixel wells.

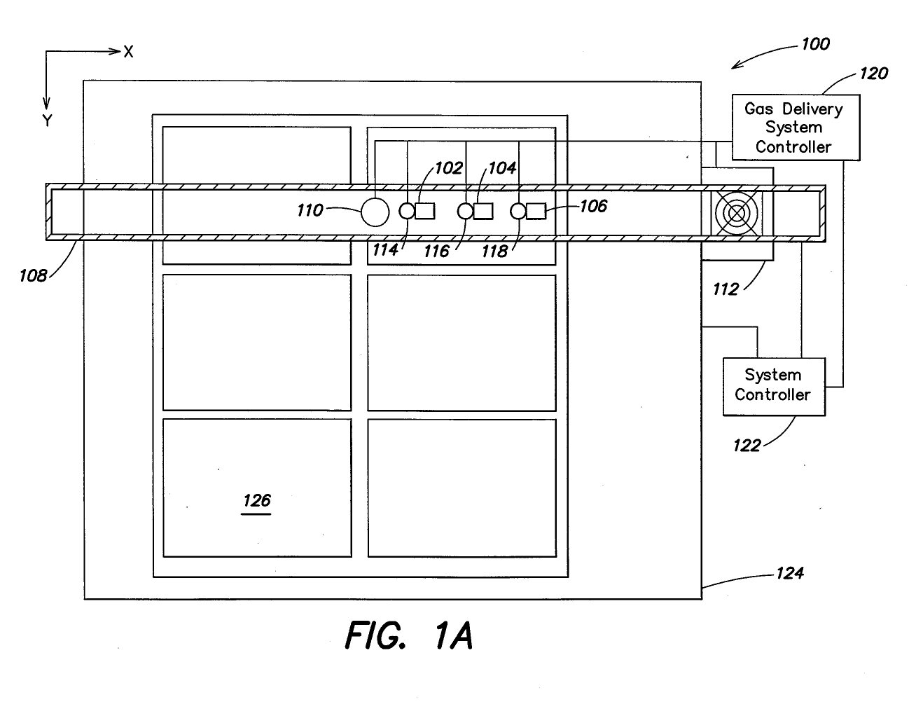

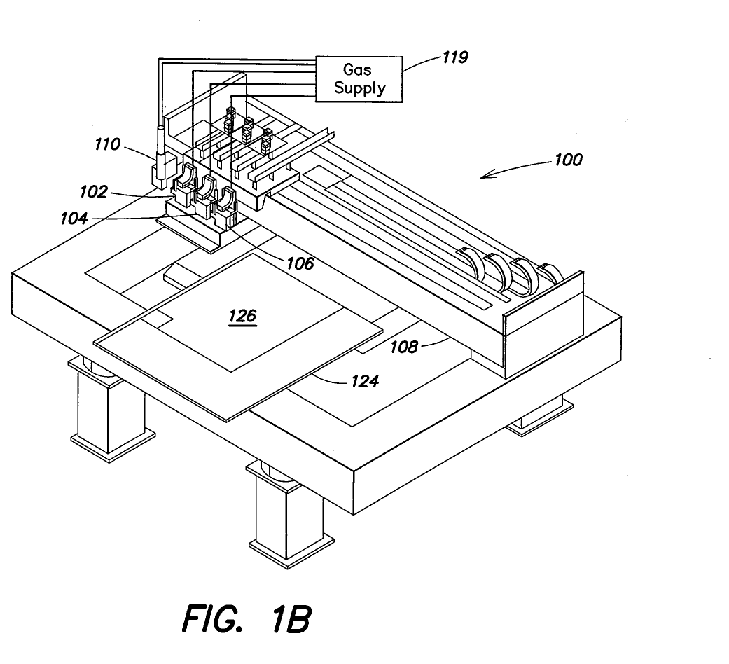

Turning to FIGS. 1A and 1B, a top schematic view and a perspective view, respectively, of an inkjet printing system 100 according to the present invention are depicted. The inkjet printing system 100 of the present invention, in an exemplary embodiment, may include print heads 102, 104, 106. Print heads 102, 104, 106 may be supported on a print bridge 108. Print bridge 108 may also support pressurized gas delivery systems 110 and/or 112 and/or 114, 116, and 118. Pressurized gas delivery systems 110-118 may be coupled to a gas supply 119 (FIG. 1B) and a pressurized gas delivery system controller 120 (FIG. 1A). The pressurized gas delivery system controller 120 may be logically (e.g., electrically, wirelessly, optically, etc.) and/or mechanically coupled to the pressurized gas delivery systems 110-118. Similarly, print heads 102-106 and print bridge 108 may be coupled to a system controller 122. The system controller 122 may be logically (e.g., electrically) and/or mechanically coupled to the print heads 102-106 and print bridge 108. In some embodiments, the pressurized gas delivery system controller 120 may be directly coupled to, in communication with, and/or under the control of the system controller 122. In additional or alternative embodiments, the pressurized gas delivery system controller 120 and the system controller 122 may be one in the same. The inkjet printing system 100 may also include a stage 124 which may support a substrate 126.

In the exemplary embodiments of FIGS. 1A and 1B, the print bridge 108 may support print heads 102-106. Although three print heads are shown on print bridge 108 in FIGS. 1A and 1B, it is important to note that any number of print heads may be mounted on and/or used in connection with the print bridge 108 (e.g., 1, 2, 4, 5, 6, 7, etc. print heads). Print heads 102-106 may be capable of dispensing a single color of ink or, in some embodiments, may be capable of dispensing multiple colors of ink.

In operation, the pressurized gas delivery systems 110-118 may apply gas pressure to the pixel wells in a scanning process that coincides with the printing process. Alternatively or additionally, the scanning process may be performed after printing has completed. In some embodiments, the scanning process may be performed perpendicular to the printing direction while in other embodiments, the scanning may be in the printing direction. Although not shown, the substrate (and the inkjet printing system 100) may be enclosed in a chamber adapted to contain pressurized gas/air. In some embodiments, the chamber may be adapted to heat the substrate. The scanning process may be performed under fixed or variable heat and pressure recipes within the chamber.

The inkjet printing system 100 of the present invention may include any number of pressurized gas delivery systems 110-118 (e.g., 1, 2, 3, 4, 5, 6, etc.) or it may include a single system with any number of nozzles. Exemplary pressurized gas delivery systems suitable for use with an inkjet print system 100 according to the present invention include the Continuous Gas System available from Praxair Corporation.

Pressurized gas delivery systems 110-118 may include one or more plenums having an opening or an array of nozzles adapted to dispense a curtain of pressurized gas onto a substrate. The opening or nozzles may be round, rectangular, or any suitable shape. For example, the curtain of pressurized gas may by formed by releasing the gas through a rectangular slit in a plenum. In some embodiments, the pressure of the gas may be controlled at the gas supply 119 and/or by adjusting the opening of the pressurized gas delivery systems 110-118. The pressure of the gas may be varied depending upon the desired profile of the ink in the pixel well. A profile suitable for use in manufacturing color filters for displays may be achieved using gas pressures in the range of approximately 5 to 150 psi. However, other pressures may be used. The opening(s) through which pressurized gas is released upon the substrate may be located from approximately 2.0 mm to approximately 10 mm above the substrate. Other distances between the opening and the substrate may be used.

In a first exemplary embodiment, the pressurized gas delivery system 110 may be coupled to the print bridge 108 in a position and manner similar to that used for a print head. That is, the pressurized gas delivery system 110 may be capable of similar rotation and movement as the print heads 102-106 and may be moved adjacent the print heads 102-106 or may be spaced apart from them. The pressurized gas delivery system 110 may include a single nozzle or, in some embodiments, nozzles (e.g., 2, 3, 4, . . . 100, 101, etc.) in a cluster or array. In some embodiments, the gas delivery system 110 may be adapted to sense the amount of pressure being applied to the ink in the pixel wells and provide a feedback signal to the pressurized gas delivery system controller 120. Pressure, optical, and/or temperature sensors may be included in the pressurized gas delivery system 110 to collect and provide feedback and/or feed-forward data. The pressurized gas delivery system 110 may be positioned on either side of the print heads 102-106 or may be positioned interstitially.

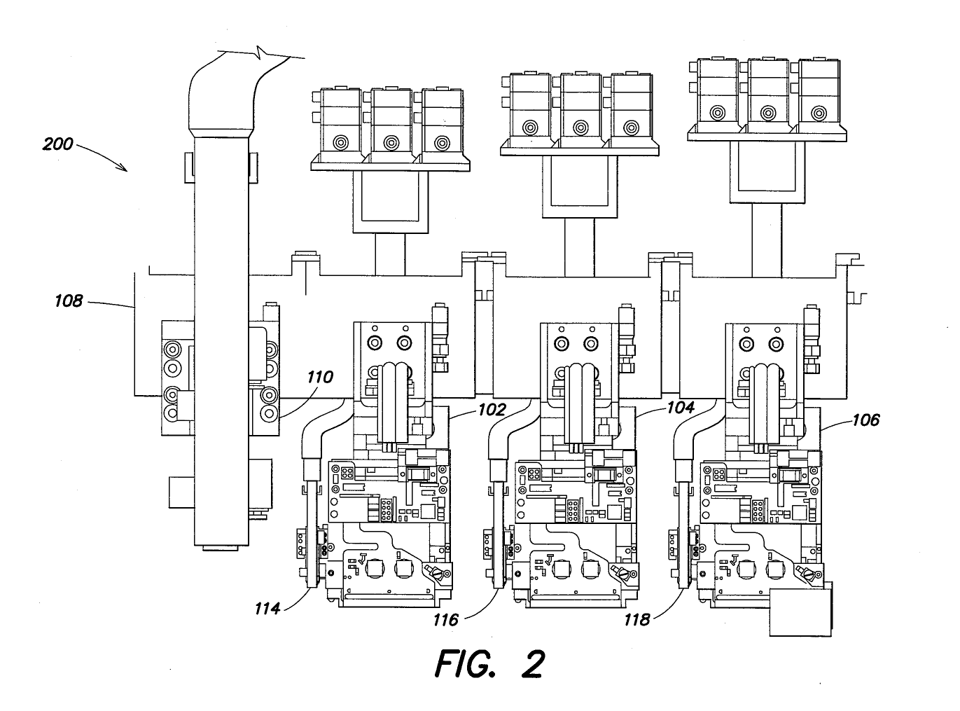

In one or more embodiments, the pressurized gas delivery system 110 may be positioned to the left of the print heads 102-106 (e.g., as shown in FIGS. 1A, 1B, and 2). With the pressurized gas delivery system 110 positioned to the left of the print heads 102-106 and a print pass proceeding from left to right (e.g., ink is deposited into a column of pixel wells on a substrate, followed by the stage shifting to the left in preparation for the next print pass), the pressurized gas delivery system 110 will first adjust the ink profile of pixel wells just printed. In some embodiments, the pressurized gas delivery system 110 may also be capable of adjusting ink profiles of previous print passes, the most recently printed pass, and/or the current print pass. The pressurized gas delivery system 110 may be positioned to adjust the ink profiles of pixel wells on the substrate located directly beneath the associated gas delivery nozzle(s) (e.g., adapted to adjust ink profiles of pixel wells printed in previous passes). Alternatively, pressurized gas delivery system 110 may be angled to adjust profiles of pixel wells that lie along a print pass in progress or may be angled in any direction to adjust profiles of pixel wells at various portions of the substrate.

In a second exemplary embodiment, the pressurized gas delivery system 112 of FIG. 1A may be coupled directly to and supported by the print bridge 108. This coupling location may be adjacent the print heads 102-106 or may be located elsewhere on the print bridge 108. The pressurized gas delivery system 112 may include a single nozzle or, in some embodiments, multiple nozzles arranged in an array.

In a third exemplary embodiment, the pressurized gas delivery systems 114-118 may be attached to and adjacent the print heads 102-106. That is, pressurized gas delivery system 114 may be separately mounted on print bridge 108 immediately adjacent print head 102 or may be mounted to the same assembly as print head 102 such that any movement by print head 102 will coincide with (e.g., cause) movement of pressurized gas delivery system 114. Similarly, pressurized gas delivery system 116 may be mounted with or adjacent print head 104 and pressurized gas delivery system 118 may be mounted with or adjacent print head 106. In some embodiments, pressurized gas delivery systems 114-118 may each include a plenum with an opening or openings adapted to create a curtain of pressurized gas. Each print head 102-106 may have an associated pressurized gas delivery system 114-116.

In embodiments where each print head 102-106 has a corresponding pressurized gas delivery system 114-118, each pressurized gas delivery system 114-116 may be oriented to apply pressure to a different set of pixel wells. For example, during a printing operation where the printing proceeds from left to right, pressurized gas delivery system 118 may adjust ink profiles of a printed column of pixel wells. The pressurized gas delivery system 116 may adjust ink profiles of two filled columns of pixel wells. Pressurized gas delivery system 114 may adjust ink profiles of three filled columns.

Alternatively, pressurized gas delivery systems 114-118 may include more than one nozzle such that the nozzles are clustered at one or more print heads 102-106 and one or more print heads do not have an associated pressurized gas delivery system 114-118. For example, in some embodiments, print head 102 may have a pressurized gas delivery system 114 mounted along with the print head. The pressurized gas delivery system 114 may include two or more nozzles, each capable of adjusting ink profiles differently. Print heads 104, 106 may not include a pressurized gas delivery system 116, 118. When two nozzles are incorporated in a pressurized gas delivery system 114, one nozzle may supply gas at a first pressure to adjust a first type of ink (or cause a first type of profile) in a first pixel well and one nozzle may supply gas at a second, different pressure to adjust the profile of a second type of ink (or cause a second type of profile) in a second pixel well. Alternatively or additionally, differently pressurized gases dispensed from different nozzles may be used to adjust the profiles of inks at different stages of curing and/or within a single pixel well.

When three nozzles are incorporated into a pressurized gas delivery system 114, each nozzle may be capable of adjusting a different portion of an ink profile within a pixel well through the use of differently pressurized gases. For example, pressured gas aimed at either end of a pixel well may be applied at a first pressure while pressurized gas at a second pressure may be applied to a center portion of the pixel well. If the first pressure is higher than the second pressure, a profile having a relatively high center point and lower end points may be achieved. Alternatively, a single nozzle applying pressurized gas at a variable pressure as it moves along the pixel well may be used to achieve a similar profile.

Pressurized gas delivery systems 110-118 may be coupled to the pressurized gas delivery system controller 120 logically (e.g., electrically, wirelessly, optically, etc.) and/or mechanically. The pressurized gas delivery system controller 120 may include software capable of selectively applying pressurized gas to pixel wells as described above. The pressurized gas delivery controller 120 may be capable of processing and/or storing feedback/feed-forward data received from each pressurized gas delivery system 110-118. The feedback/feed-forward data may indicate the amount of pressure actually being applied to the pixel wells and/or the temperature of the area near the pixel wells. The feedback data may be used to adjust the amount of pressure being applied to the pixel wells.

In alternative embodiments, each pressurized gas delivery system 110-118 may have an associated pressurized gas delivery system controller (e.g., each pressurized gas delivery system 110-118 may be capable of individually responding to feedback/feed-forward data). The feedback/feed-forward data from the pressurized gas delivery systems 110-118 may include location coordinates (e.g., on an XY plane) of the sensed region. The location data may also be retrieved or received from the printing system (e.g., system controller 122).

The pressurized gas delivery system controller 120 may be any suitable computer or computer system, including, but not limited to, a mainframe computer, a minicomputer, a network computer, a personal computer, and/or any suitable processing device, component, or system. The pressurized gas delivery system controller 120 alternatively may comprise a dedicated logic circuit or any suitable combination of hardware and/or software. The pressurized gas delivery system controller 120 may be adapted to control any of the pressurized gas delivery systems 110-118, including controlling the movement of each pressurized gas delivery system 110-118 rotationally and in both positive and negative lateral displacement directions along the X-axis; the positive X-axis direction being indicated by the frame of reference arrow labeled X in FIG. 1A. Additionally, the pressurized gas delivery system controller 120 may be capable of controlling the angle at which pressurized gas is applied by the pressurized gas delivery systems 110-118 relative to the substrate, the temperature and pressure of the pressurized gas, the distance of the pressurized gas delivery systems 110-118 from the substrate, or perform any other control necessary.

As noted above, the system 100, in an exemplary embodiment, may include the system controller 122. As with the pressurized gas delivery system controller 120, the system controller 122 may be any suitable computer or computer system, including, but not limited to, a mainframe computer, a minicomputer, a network computer, a personal computer, and/or any suitable processing device, component, or system. The system controller 122 alternatively may comprise a dedicated logic circuit or any suitable combination of hardware and/or software. The system controller 122 may be adapted to control any of the print heads 102-106 through the print head support 108, including controlling the movement of each print head 102-106 rotationally and in both positive and negative lateral displacement directions along the X-axis; the positive X-axis direction being indicated by the frame of reference arrow labeled X in FIG. 1A. The system controller 122 may also control any and all inkjet printing and maintenance operations capable of being performed by the print head support 108, and/or the print heads 102-106.

The system controller 122 may interface with the pressurized gas delivery system controller 120 and/or may communicate directly with the pressurized gas delivery systems 110-118. Either the pressurized gas delivery system controller 120 or the system controller 122 may determine adjustments to be made to the pressure and/or temperature of the gas, the orientation or position of the nozzles, and/or the timing of the application of pressurized gas.

FIG. 2 depicts a close-up view of an exemplary embodiment of a print head portion 200 of an inkjet printing system 100 (FIGS. 1A & 1B) according to the present invention. As indicated above, the print head portion 200 may include print heads 102, 104, and 106 mounted on print bridge 108. Also mounted on print bridge 108, in a position and manner similar to those shown in FIGS. 1A and 1B, may be pressurized gas delivery systems 110, 114, 116, and 118. Pressurized gas delivery system 110 may be movable, rotatable, and angleable in such ways as to allow the system to adjust the ink profile of pixel wells of a current or prior printing pass. In an alternative embodiment, pressurized gas delivery systems 114-118 may be mountable in the same mount as any of print heads 102-106 or to the print heads 102-106 themselves and may be similarly movable, rotatable, and angleable. Pressurized gas delivery systems 114-118 may be mounted on any side of print heads 102-106 to adjust current and prior printed pixel wells. For example, a pressurized gas delivery system 114 mounted to the left of print head 102 may be capable of adjusting ink profiles of pixel wells in the prior print pass or passes. If pressurized gas delivery system 114 were mounted on the right side of print head 102, the pressurized gas delivery system 114 may be capable of adjusting ink profiles of pixel wells printed in the prior print pass or passes of print head 104.

Pressurized gas delivery systems 114-118 may also be mounted fore and/or aft of any of print heads 102-106 relative to the print direction (which may be both positive and negative directions along the Y-axis, the positive Y-axis direction being indicated by the frame of reference arrow labeled Y in FIG. 1A). In this configuration, pressurized gas delivery systems 114-118 may be capable of adjusting ink profiles immediately following the dispensing of ink (thus not having to wait until an entire print pass is completed) regardless of whether the substrate is being moved in the positive or negative Y-axis direction. For example, an aft-mounted gas delivery system may apply pressurized gas when the substrate is moved in the negative Y-axis direction while a fore-mounted gas delivery system may apply pressurized gas when the substrate is moved in the positive Y-axis direction.

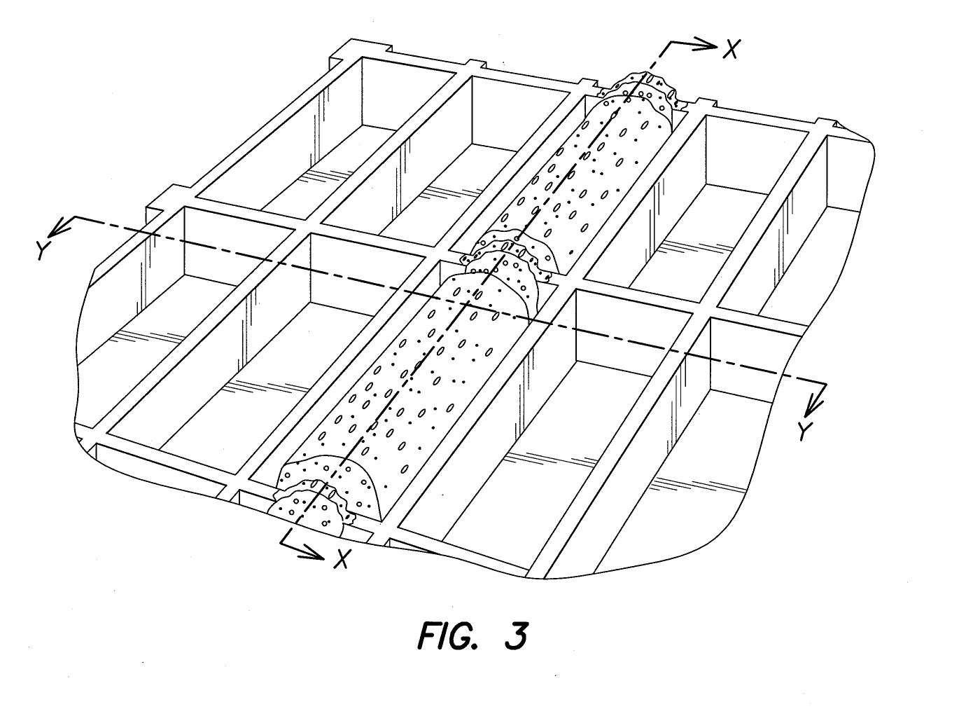

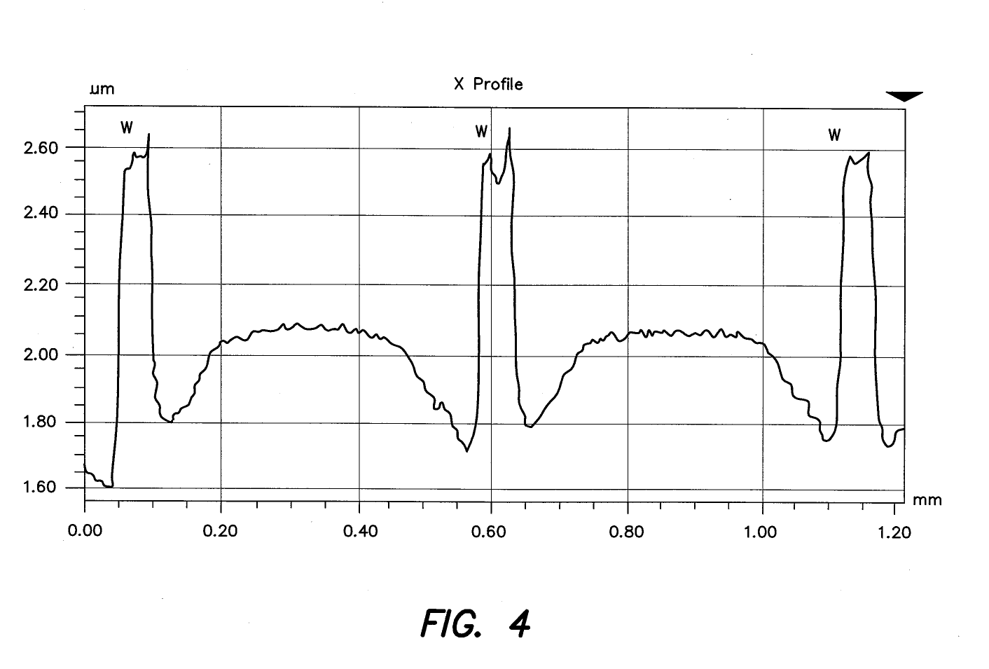

FIG. 3 is an image of an example matrix of pixel wells. Two of the ten pixel wells shown are depicted as filled with ink while the other eight are empty. FIG. 4 depicts an example of a graph of the “X” profile of the ink within the two filled pixel wells taken as a cross-section along the X-X line in FIG. 3. Note that the ink is unevenly distributed (e.g., the top surface has a dome shape) and generally drawn away from the matrix walls which are represented by the narrow peaks labeled W. The level of ink at the highest (thickest) point is approximately 2.1 micrometers. The thickness non-uniformity is sufficient to cause color non-uniformity within each pixel and thus, within the entire display object. Such color non-uniformity may significantly degrade the quality of the color filter.

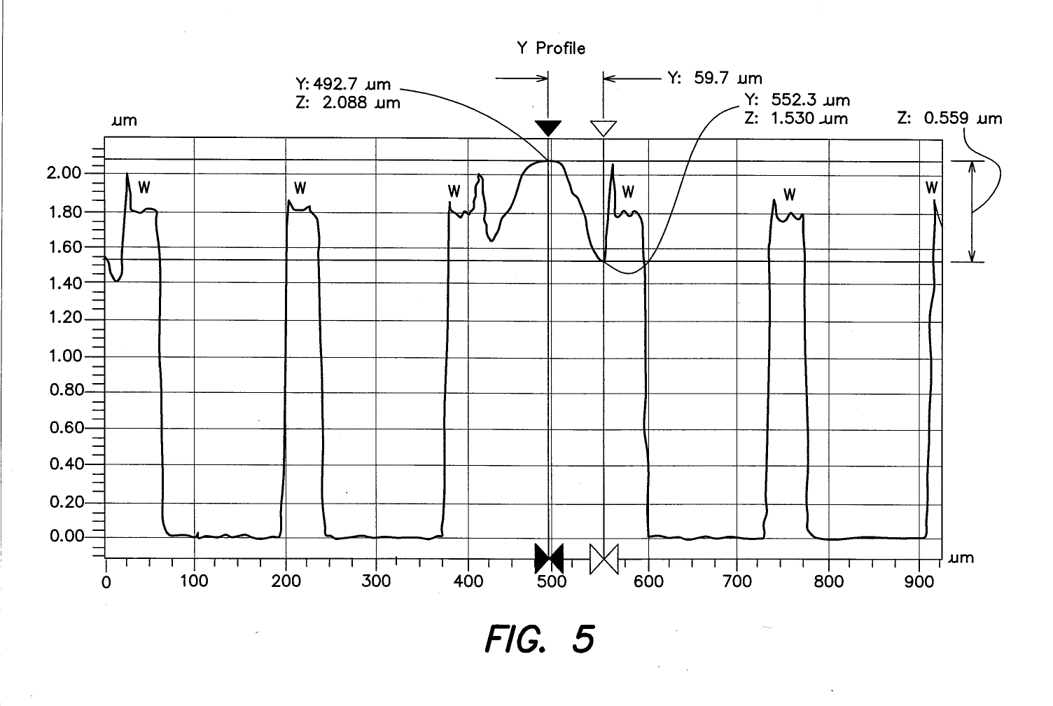

FIG. 5 similarly depicts an example of a graph of the “Y” profile of the ink within one of the filled pixel wells (and four empty wells) taken as a cross-section along the Y-Y line in FIG. 3. Note that from this perspective the ink is also unevenly distributed and generally drawn away from the matrix walls represented by the narrow peaks labeled W. As with the X profile of FIG. 4, the level of ink at the highest (thickest) point in the Y profile is approximately 2.1 micrometers. Thus, the image in FIG. 3 and the associated profile graphs of FIGS. 4 and 5, depict an example of the distribution of ink as it may typically be disposed after being deposited into pixel wells by an inkjet printing system.

The present invention provides various methods of adjusting (e.g., flattening) uneven profiles after printing. The ink thickness variations can be reduced so that thickness and color uniformity is greatly improved at both the pixel level and the display object level (e.g., the panel level). There are a number of variations of the methods of the present invention that may be employed to achieve a desired ink profile. In a first exemplary variation, printed substrates may be placed into a pressurized chamber with a pressure ranging from approximately 5 to approximately 150 psi for approximately ten seconds to approximately five minutes. In a second exemplary variation, printed substrates may be placed into a pressurized chamber with a pressure ranging from approximately 5 to approximately 30 psi using either heated compressed nitrogen (N2) or heated compressed air for approximately ten seconds to approximately five minutes. In either case, the heated gas may be in the range from approximately 40 degrees Celsius to approximately 80 degrees Celsius. However, in either of these first two variations, other temperature, pressure, and time ranges may be used.

In a third exemplary variation of the present methods, substrates may be scanned with a pressurized gas delivery system (e.g., a compressed N2 or compressed air nozzle) at a rate of approximately five feet per minute (e.g., one to ten ft/min), either following the print direction or approximately perpendicular to the print direction, within a heated chamber. The chamber may be heated within the range from approximately 40 degrees Celsius to approximately 80 degrees Celsius. The scanning may be performed concurrently with the printing (e.g., immediately after the ink is deposited) or after printing has been completed entirely or partially. The pressurized gas may be in the range of approximately five to approximately forty psi. However, other chamber temperatures, scan rates, directions, pressures, time frames, and gases may be used.

In a fourth exemplary variation of the present methods, substrates may be scanned with a heated, pressurized gas delivery system (e.g., a heated compressed N2 or heated compressed air nozzle) at a rate of approximately five feet per minute (e.g., one to ten ft/min) following the print direction or approximately perpendicular to the print direction. The scanning may be performed concurrently with the printing (e.g., immediately after the ink is deposited) or after printing has been completed entirely or partially. The pressurized gas may be in the range of approximately five to approximately forty psi. The temperature of the gas may be in the range from approximately 40 degrees Celsius to approximately 80 degrees Celsius. However, other gas temperature ranges, scan rates, directions, pressures, time frames, and gases may be used.

In alternative or additional embodiments, the substrates may be heated. The stage upon which the substrate is supported may include heating elements controlled by either the pressurized gas delivery system controller 120 or the system controller 122. Alternatively, a spot heater coupled to the print bridge may be employed. The substrates may be heated to a temperature of approximately 40 degrees Celsius to approximately 80 degrees Celsius. Other temperatures may be used.

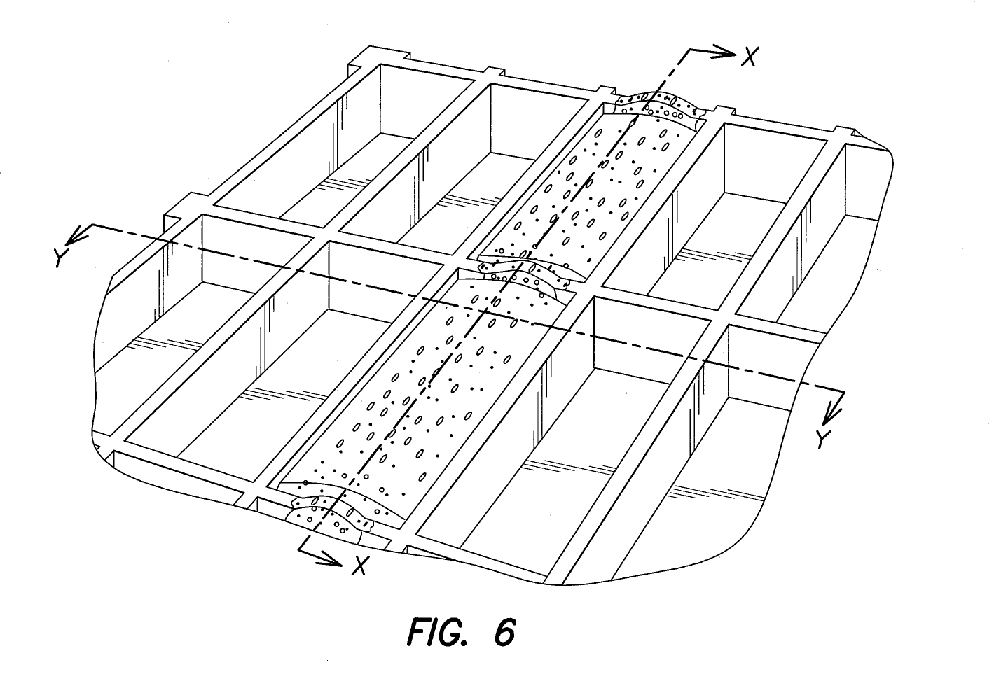

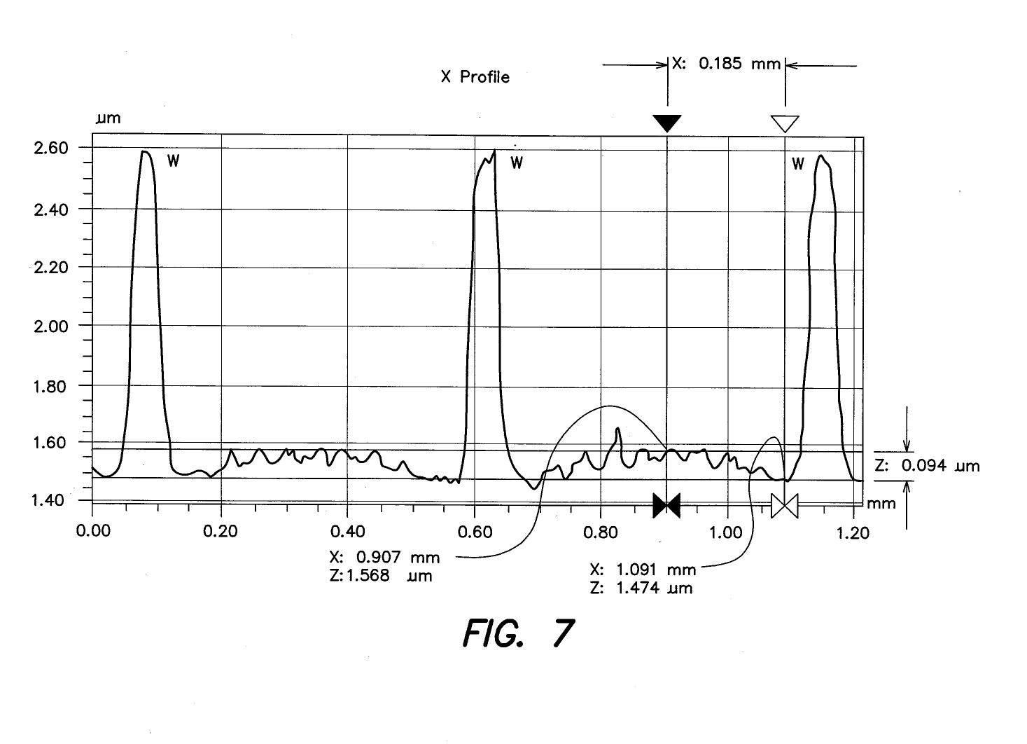

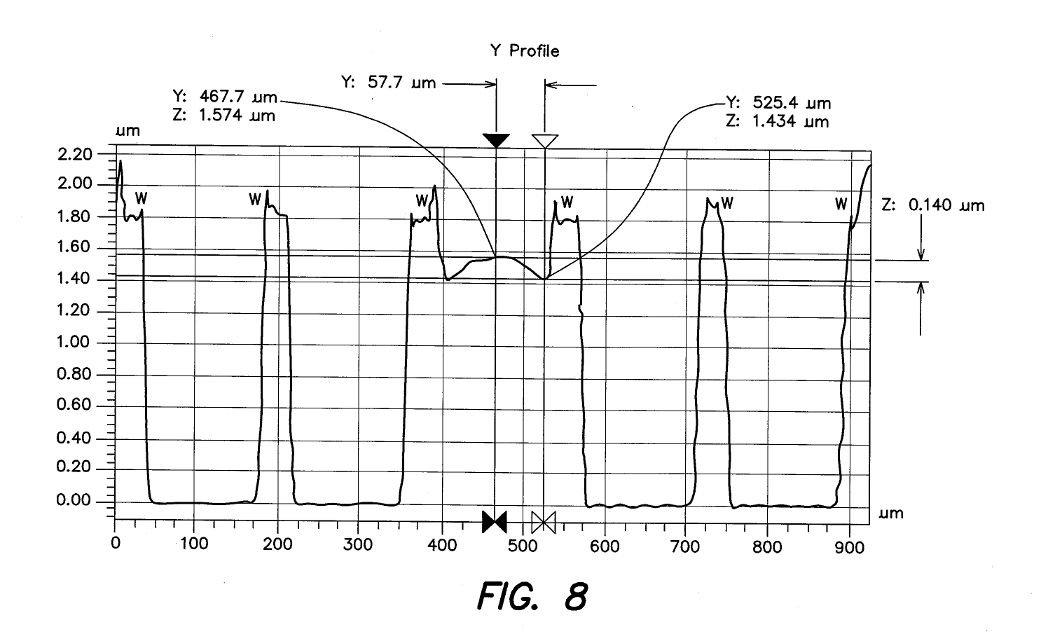

Turning to FIG. 6, an image depicting the example matrix of FIG. 3 after the methods of the present invention have been applied to adjust the ink in the filled pixels is provided. According to the present invention, as described above, pressurized gas is used to adjust the distribution of ink within the pixel wells. FIG. 7 depicts an example of a graph of the adjusted X profile of the ink within the two filled pixel wells taken as a cross-section along the X-X line in FIG. 6. Note that the ink is much more evenly distributed as compared to the “before” (unadjusted) X profile shown in FIG. 4. Also note that, while the shape of the profile includes a moderate crown (a shape that may be desirable for color filter applications), the ink is not drawn away from the matrix walls (represented by the narrow peaks labeled W) as much as in FIG. 4. Similarly, FIG. 8 depicts an example of a graph of the adjusted Y profile of the ink within one of the filled pixel wells (and four empty wells) taken as a cross-section along the Y-Y line in FIG. 6. Note that from this perspective the ink is also more evenly distributed as compared to the “before” (unadjusted) Y profile shown in FIG. 5. Note that a comparison of the variation in the surface height before the adjustment of the present invention versus after shows that the surface is much flatter after. Specifically, the dimension labeled Z (variation in the surface height before) in FIG. 5 is 0.558 μm while the dimension labeled Z (variation in the surface height after) in FIG. 8 is 0.140 μm. Thus, the image in FIG. 6 and the associated profile graphs of FIGS. 7 and 8, depict an example of the distribution of ink as it may be disposed after being adjusted according to the systems and methods of the present invention.

In some embodiments, the fill profile of pixel wells may be concave before the present invention is applied to adjust the profile. In such embodiments, the pressurized gas may be directed at and angle toward the side walls of the pixel wells and/or to the outer edges of the pixel wells to aid in adjusting the profile. Alternatively, a direct downward application of pressurized gas directed at the outer edges of the pixel wells or to the entirety of the pixel wells may be used to modify the profile. Alternatively, additional ink may be added to such partially filled ink wells.

Turning to FIG. 9, a continuum of wetability 900 is depicted. As indicated above, for a given droplet A on a solid surface B the contact angle θ is a measurement of the angle formed between the surface of a solid B and the line tangent to the droplet A radius from the point of contact with the solid B. The contact angle θ is related to the surface tension. A contact angle θ of zero degrees 902 results in wetting, while an angle θ between zero and ninety degrees 904 results in spreading of the drop (due to molecular attraction). A contact angle θ of ninety degrees 906 may result in steady state in which the surface tension stops the spreading of the liquid. Angles θ greater than ninety degrees 908 indicate that the liquid tends to bead or shrink away from the solid surface.

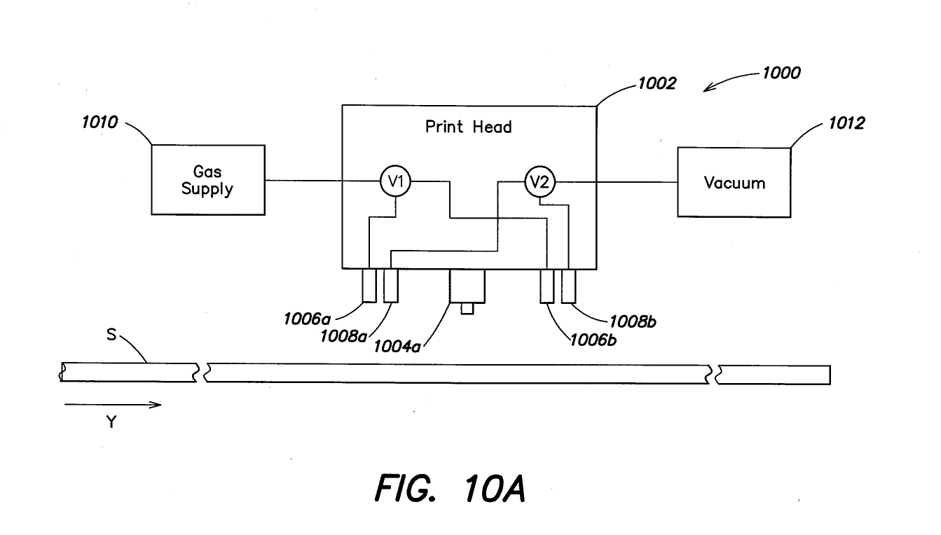

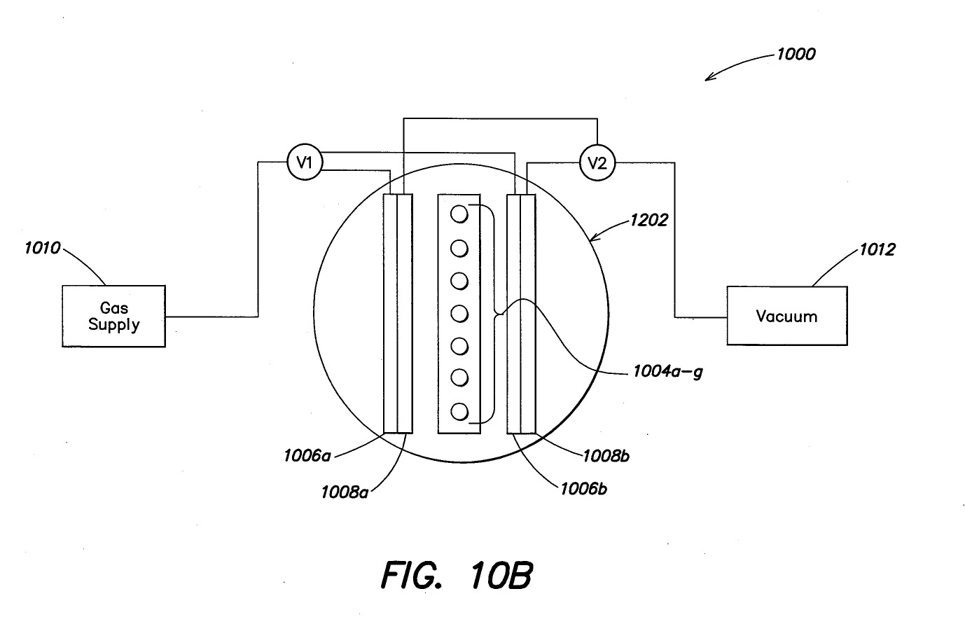

Apparatus and methods for preparing a substrate for printing are now described with respect to FIGS. 10A through 12B.

Turning to FIGS. 10A and 10B, a side and bottom schematic view, respectively, of an inkjet printing system 1000 according to the present invention are depicted. The inkjet printing system 1000 of the present invention, in an exemplary embodiment, may include one or more print heads 1002, which may be the same as or similar to print heads 102-106 of FIGS. 1A and 1B. Print head 1002 may have one or more nozzles 1004a-g.

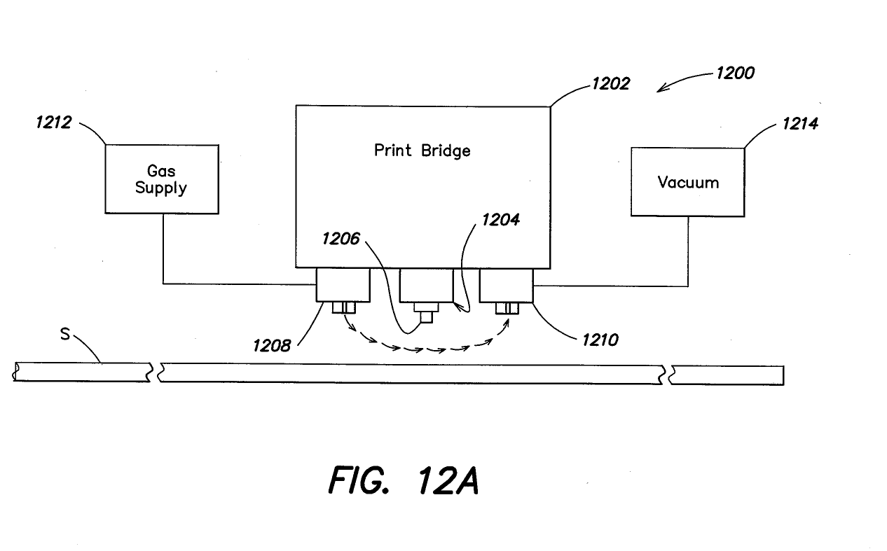

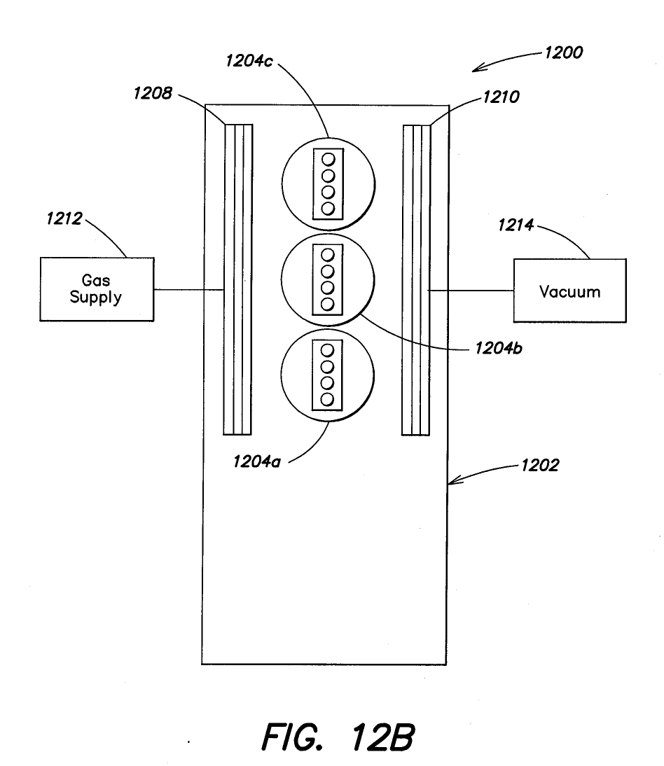

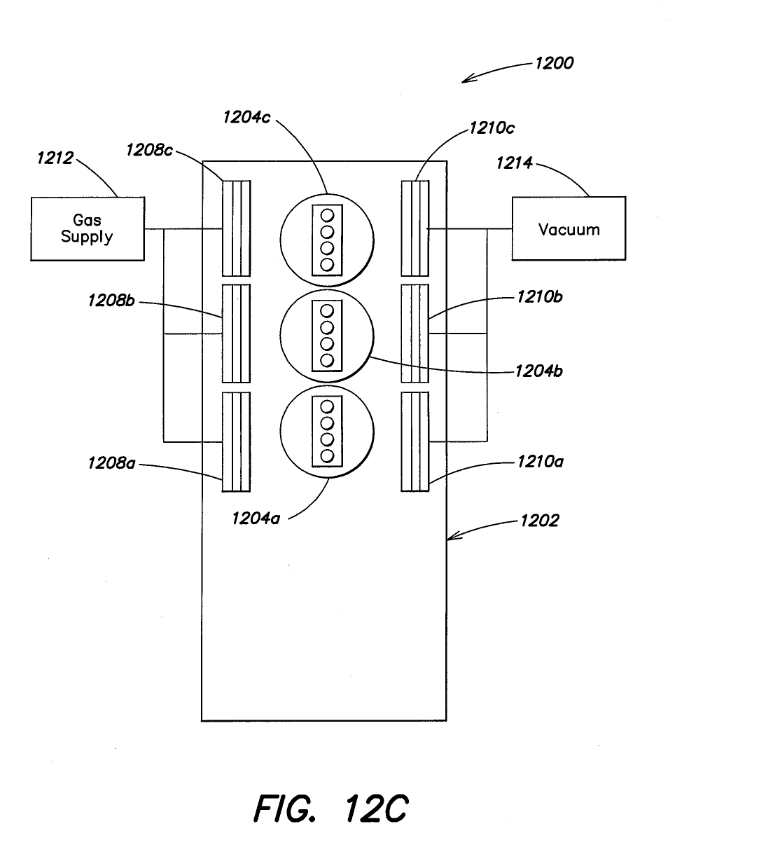

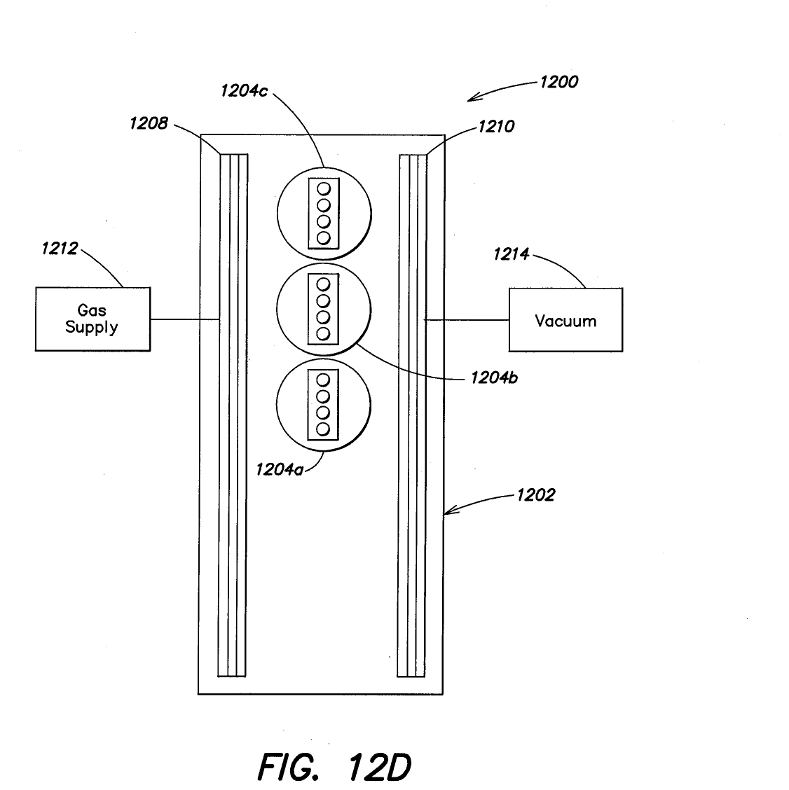

Inkjet printing system 1000 may also include gas delivery 1006a-b and/or gas recovery 1008a-b, which may be coupled to print head 1002, adjacent nozzles 104a-g as shown. Gas delivery 1006a-b and gas recovery 1008a-b may comprise multiple apertures and may be situated adjacent each other as shown in FIG. 10B. It is understood that gas delivery 1006a-b and/or gas recovery 1008a-b may be located elsewhere on the print head 1002 and/or elsewhere in the inkjet printing system 1000 (as will be discussed below with respect to FIGS. 12A-D). Likewise, greater or lesser numbers of gas deliveries 1006a-b and gas recoveries 1008b may be used. Gas delivery 1006a-b and gas recovery 1008a-b may be slit-like apertures (e.g., an air knife or similar) that run adjacent the nozzles 1004a-g, as shown in FIG. 10B. In other embodiments, gas delivery 1006a-b and gas recovery 1008a-b may comprise multiple apertures (e.g., an opening adjacent each nozzle, openings not aligned with nozzles, etc.). The apertures of gas delivery 1006a-b and gas recovery 1008a-b may also be any other appropriate shape.

Gas delivery 1006a-b may be coupled to a gas supply 1010 and a gas delivery system controller (not shown), such as the gas delivery system controller 120 of FIGS. 1A and 1B. Gas recovery 1008a-b may be coupled to a vacuum 1012. Gas recovery 1008a-b and/or vacuum 1012 may be coupled to the gas delivery system controller, a system controller, or a unique intake controller similar to the controllers described above. Print head 1002 may be coupled to the system controller, such as the system controller 122 described with respect to FIGS. 1A and 1B above.

The inkjet printing system 1000 may be adapted to print to a substrate S.

In operation, the gas supply 1010 may supply a purge gas (e.g., compressed air, fresh air, nitrogen, etc.) to the gas delivery 1006a-b. The purge gas may be passed through a series of regulator, control, and adjustment valves (not shown) (e.g., needle valves, mass flow controller, etc.) between the gas supply 1010 and the gas delivery 1006a-b. The gas delivery 1006a-b may direct (e.g., through a valve, vent, aperture, etc.) the purge gas toward the substrate S such that the purge gas may blow or evaporate any residual solvent and/or contaminants away from the surface of the substrate S. This purging may help create a similar substrate surface condition for every print pass. That is, because the purge gas will remove contaminants and/or substantially equalize any amount of solvent present on the substrate surface, ink jetted onto the substrate S will mix with no or equal amounts of solvent over the entire surface. This will facilitate uniform line width jetting by each nozzle 1004a-g.

In some embodiments, the gas recovery 1008a-b may be provided to capture or reclaim the purge gas and any particulates which may be blown from the surface of the substrate and/or any evaporates. The vacuum 1012 may assist in exhausting the purge and/or other gases from the printing environment through the gas recovery 1008 by drawing off the purge gases through the gas recovery 1008, thus leaving a clean surface for subsequent printing.

In an exemplary embodiment, as the substrate S is moved below the stationary print head 1002 in the positive Y direction during a print pass, as indicated by the Y-axis of FIG. 10A, the gas supply 1010 may supply a purge gas to the gas delivery 1006a. (Note that gas delivery 1006b is turned off (via valve V1) so that no purge gas flows through gas delivery 1006b while the substrate S is moved in the positive Y direction.) The gas delivery 1006a may direct the purge gas toward the passing substrate S. Nozzles 1004a-g may dispense ink onto the substrate S. Following behind the nozzles 1004a-g (relative to the substrate's motion), purge gas, particulates, contaminants, evaporates, and other substances may be collected by the gas recovery 1008b and siphoned to the vacuum 1012. (Note that gas recovery 1008a is turned off (via valve V2) so that no vacuum pressure is applied via gas recovery 1008a while the substrate S is moved in the positive Y direction.)

When the print direction changes (e.g., the substrate is moved in the negative Y direction), the alternative gas delivery 1006b and alternative gas recovery 1008a are turned on and the other gas delivery 1006a and gas recovery 1008b are turned off. The switching of the gas recovery and delivery may be effected through a system of automated electrically valves V1, V2 that open and close based on the direction of the substrate's motion. Thus, when the substrate S is moved in the negative Y direction, the gas delivery 1006b may now direct purge gas toward the substrate S. Gas delivery 1006b is turned off by valve V1, nozzles 1004a-g may dispense ink onto the substrate S, and purge gas, particulates, contaminants, evaporates, and other substances may be collected by the gas recovery 1008a. Gas recovery 1008b is turned off by valve V2. The recovered matter is siphoned to the vacuum 1012. The gas recovery and delivery will switch again when the direction of the substrate changes again with the next print pass. In this way, purge gas may be delivered to the substrate S immediately prior to ink landing on the purged area of the substrate S and the gas is drawn away from the substrate S immediately after the ink lands regardless of the current print direction.

In the same or other embodiments, the gas supply 1010 may supply a purge gas to the gas delivery 1006a. The gas delivery 1006a may direct the purge gas toward the substrate S. Gas recovery 1008a may intake the purge gas, etc. in advance of ink being deposited on the substrate S via nozzles 1004a-g. During a subsequent print pass in the opposite direction, gas supply 1010 may supply a purge gas to the gas delivery 1006b. The gas delivery 1006b may direct the purge gas toward the substrate S. Gas recovery 1008b may intake the purge gas, etc. in advance of ink being deposited on the substrate S via nozzles 1004a-g. In this embodiment, the purge gas may be delivered to and drawn away from an area on the substrate S prior to printing on the area via nozzles 1004a-g irrespective of the current print direction. In some embodiments, the relative locations of gas delivery 1006b and gas recovery 1008b may be switched relative to the nozzles 1004a-g. Any suitable combination of uses and numbers of the gas deliveries 1006a-b and gas recoveries 1008a-b that is practicable may be used. For example, gas delivery 1006a may direct purge gas toward the substrate while gas recovery 1008b may draw the spent purge gas away.

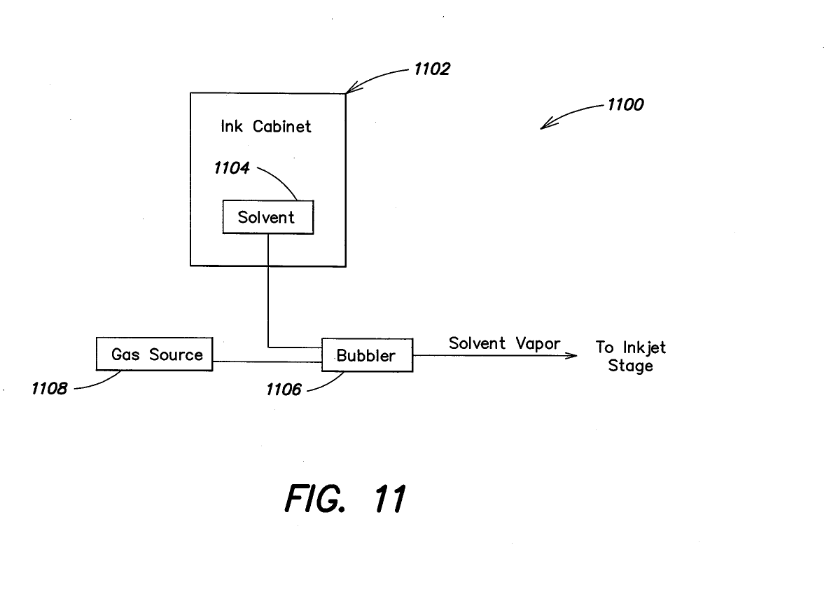

Turning to FIG. 11, a portion of an inkjet printing system 1100 for an alternative embodiment is shown. The inkjet printing system 1100 includes an ink cabinet 1102 which, among other things, may house a solvent tank 1104. Ink cabinet 1102 may be any enclosure or space at which solvent tank 1104 may reside, such as the ink delivery module described in previously incorporated co-pending U.S. Provisional Patent Application Ser. No. 60/721,340, filed Sep. 27, 2005 and entitled “INKJET DELIVERY MODULE.” For example, the ink cabinet 1102 may also house ink reservoirs, ink pumps, solvent pumps, valves, monitoring equipment, etc. (not shown). The solvent tank 1104 may be in fluid communication with a bubbler 1106. Also in fluid communication with the bubbler 1106 may be a gas source 1108. The gas source 1108 may be similar to the gas supply 1010 described above with respect to FIGS. 10A and 10B. The bubbler 1106 may be adapted to pass solvent vapor and/or other gases to an inkjet stage or any inkjet printing apparatus. In some embodiments, the bubbler 1106 may serve as the gas supply 1010 previously described.

Solvents for use in inkjet printing may be housed in the solvent tank 1104. Exemplary solvents include PGEMA (CAS 165-85-5), n-amyl propionate (CAS 624-54-4), or any solvent compatible with inks used in ink jetting. In some embodiments, the vapor pressure of these solvents should be between about 0.01 to 1000 mm Hg at about 25° C. Preferably, the vapor pressure of these solvents should be between about 0.5 to 300 1000 mm Hg at about 25° C. Other ranges of vapor pressures and/or temperatures may be used. Higher vapor pressure solvents will generally allow the solvent to evaporate more quickly from the surface of the substrate. Lower vapor pressure solvents may require heating to evaporate the solvent.

In operation, solvent held in one or more solvent tanks 1104 may pass solvent to the bubbler 1106. Similarly, the gas source 1108 may pass a purge gas (e.g., compressed air, fresh air, nitrogen, etc.) to the bubbler 1106. The bubbler 1106 may mix products from the purge gas source 1108 and the solvent tank 1104.to pass purge gas saturated with solvent vapor to an inkjet printing apparatus, such as the gas delivery 1006 of FIGS. 10A and 10B, for distribution over the surface of a substrate. Flowing purge gas saturated with solvent vapor over the surface of a substrate may present a uniform volume of solvent onto which ink may be jetted. Controlling the amount of solvent present on the substrate surface may allow control over the spreading of the ink and/or other ink characteristics.

FIGS. 12A-D depict various embodiments of another aspect of the present invention. FIG. 12A is a simplified side schematic view of an inkjet printing system 1200 according to some aspects of the invention. The inkjet printing system 1200 comprises a print bridge 1202 onto which are mounted one or more print heads 1204 which may dispense ink via a nozzle 1206 onto a substrate S. Adjacent the print head 1204 may be gas delivery 1208 and gas recovery 1210. Gas delivery 1208 and gas recovery 1210 may be coupled to the print bridge 1202, mounted through the print bridge 1202 (e.g., the print bridge 1202 may be adapted to facilitate passing gas through the bridge structure), or in any other suitable manner. In some embodiments, the gas delivery 1208 and/or gas recovery 1210 may be spaced apart from the print heads 1204 by a predetermined distance. The particular arrangements of gas delivery 1208 and gas recovery 1210 will be described in more detail below with respect to FIGS. 12B-D. Gas delivery 1208 and gas recovery 1210 may be arranged similarly to gas delivery 1006a-b and gas recovery 1008a-b of FIGS. 10A and 10B. That is, gas delivery 1208 may comprise multiple gas deliveries which may be positioned along the print head, along the print bridge, adjacent the gas recovery 1210 locations, or any other suitable location. Similarly, the gas recovery 1210 may be located in any suitable location, including having multiple apertures of which at least one may be immediately adjacent the gas delivery 1208 locations. See FIGS. 10A and 10B for detail. Note that in the simplified schematic drawings of FIGS. 12A-D, the valves and gas lines for distributing gas and vacuum to both sides of the print heads 1204a-c are not shown. However, it should be understood that gas delivery and gas recovery may be disposed on either side of the print heads 12a-c and the system 1200 is operative to turn such gas delivery and gas recovery on and off based on the direction of motion of the substrate S or other factors.

Gas delivery 1208 may be coupled to a gas supply 1212 and a gas delivery system controller (not shown), such as the gas delivery system controller 120 of FIGS. 1A and 1B. The gas delivery system controller may be operative to switch the valves (not shown) to direct the gas flow based on the direction of movement of the substrate S. The gas supply 1212 may be similar to the gas supply 1010 or the bubbler 1106 described above with respect to FIGS. 10A and 10B and FIG. 11, respectively. All usable gas flow rates and pressures may be used.

Gas recovery 1210 may be coupled to a vacuum 1214, which may be similar to the vacuum 1012 described above with respect to FIGS. 10A and 10B, and a gas recovery system controller (not shown). The gas recovery system controller may be operative to switch the valves (not shown) to direct the vacuum pressure based on the direction of movement of the substrate S. Gas recovery 1210 and/or vacuum 1214 may be coupled to the gas delivery system controller, a system controller, or a unique intake controller similar to the controllers described elsewhere in the description of the present invention. Print bridge 1202 and/or print head 1204 may be coupled to a system controller, such as the system controller 122 described with respect to FIGS. 1A and 1B above.

FIGS. 12B-D illustrate simplified bottom schematic views of various embodiments of the inkjet printing system 1200. In FIG. 12B, the print bridge 1202 may support print heads 1204a-c. Other numbers of print heads 1204 may be supported on print bridge 1202 (e.g., 1, 2, 4, 5, 6, 7, etc.). Also supported on print bridge 1202 may be gas delivery 1208 and gas recovery 1210 as described above with respect to FIG. 12A. In the particular embodiment of FIG. 12B, the gas delivery 1208 may be in fluid communication with gas supply 1212 and may be a slit-like aperture (e.g., an air knife or similar) which is substantially as long as a set of print heads 1204a-c. A set of print heads may be any number of print heads which may be grouped together. Similarly, gas recovery 1210 may be in fluid communication with vacuum 1214 and may be a slit-like aperture which is substantially as long as a set of print heads 1204a-c. Gas delivery 1208 and gas recovery 1210 may be mounted to the print bridge 1202 in a similar fashion as print heads 1204a-c. Accordingly, gas delivery 1208 and/or gas recovery 1210 may be stationary and/or may be moveable and/or rotatable to shadow the movements of print heads 1204a-c.

As shown in FIG. 12C, the print bridge 1202 may support print heads 1204a-c. Other numbers of print heads 1204 may be supported on print bridge 1202 (e.g., 1, 2, 4, 5, 6, 7, etc.). Also supported on print bridge 1202 may be gas deliveries 1208a-c and gas recoveries 1210a-c which may be similar to gas delivery 1208 and gas recovery 1210 described above with respect to FIG. 12A. Other numbers of gas deliveries 1208 and gas recoveries 1210 may be supported on print bridge 1201 (e.g., 1, 2, 4, 5, 6, 7, etc.). In the particular embodiment of FIG. 12C, the gas deliveries 1208a-c may be in fluid communication with gas supply 1212 and may be slit-like apertures (e.g., an air knife or similar) which are substantially as long as each of counterpart print heads 1204a-c. Similarly, gas recoveries 1210a-c may be in fluid communication with vacuum 1214 and may be slit-like apertures which are substantially as long as each of counterpart print heads 1204a-c. Gas deliveries 1208a-c and gas recoveries 1210a-c may be mounted to the print bridge 1202 in a similar fashion as print heads 1204a-c. Accordingly, gas deliveries 1208a-c and/or gas recoveries 1210a-c may be stationary and/or may be moveable and/or rotatable to shadow the movements of each of counterpart print heads 1204a-c.

In FIG. 12D, the print bridge 1202 may support print heads 1204a-c. Other numbers of print heads 1204 may be supported on print bridge 1202 (e.g., 1, 2, 4, 5, 6, 7, etc.). Also supported on print bridge 1202 may be gas delivery 1208 and gas recovery 1210 as described above with respect to FIG. 12A. In the particular embodiment of FIG. 12D, the gas delivery 1208 may be in fluid communication with gas supply 1212 and may be a slit-like aperture (e.g., an air knife or similar) which runs substantially the length of the print bridge 1202. Similarly, gas recovery 1210 may be in fluid communication with vacuum 1214 and may be a slit-like aperture which run substantially the length of print bridge 1202. Gas delivery 1208 and gas recovery 1210 may be mounted to the print bridge 1202 in a similar fashion as print heads 1204a-c. Accordingly, gas delivery 1208 and/or gas recovery 1210 may be stationary and/or may be moveable to shadow the movements of print heads 1204a-c. In some embodiments, the gas delivery 1208 and gas recovery 1210 may be integral to the print bridge 1202. That is, the gas delivery 1208 and gas recovery 1210 may be manufactured into or coupled to the print bridge 1202 in such a way as to allow the gas supply 1212 to communicate with the gas delivery 1208 and the gas delivery 1208 to communicate with the vacuum 1214 through the print bridge.

Operation of the embodiments of FIGS. 12A-D is discussed with particular attention to FIGS. 12A and 12B. It is understood that the modifications of FIGS. 12C and 12D may be used similarly. Specifically, though discussed as only one gas delivery 1208 and one gas recovery 1210 in FIGS. 12A and 12B, the multiple gas deliveries 1208 and gas recoveries 1210 of FIG. 12C may be operated similarly.

In operation, the gas supply 1212 may supply a purge gas (e.g., compressed air, fresh air, nitrogen, etc.) to the gas delivery 1208. The purge gas may be passed through a series of regulator, control, and adjustment valves (not shown) (e.g., needle valves, mass flow controller, etc.) between the gas supply 1212 and the gas delivery 1208. The gas delivery 1208 may direct (e.g., through a valve, vent, etc.) the purge gas toward the substrate S such that the purge gas may blow or evaporate any residual solvent and/or contaminants away from the surface or the substrate S. This purging may create a similar substrate surface condition for every print pass. That is, because the purge gas will remove contaminants and/or substantially equalize the amount of solvent present on the substrate surface, ink jetted onto the substrate S will mix with no or equal amounts of solvent over the entire surface. This will facilitate uniform line width jetting by each nozzle 1204a-c.

In some embodiments, the gas recovery 1210 may be provided to reclaim the purge gas and any particulates which may be blown from the surface of the substrate and/or any evaporates. The vacuum 1214 may assist in exhausting the purge and/or other gases from the printing environment through the gas recovery 1210 leaving a clean surface for subsequent printing.

Gas delivery 1208 and gas recovery 1210 may be moved (e.g., oscillated, swept, etc.) over the surface of the substrate S. This may aid loosening contaminants from the surface of the substrate S and/or facilitating evaporation of any solvent and/or contaminants remaining on the surface. By moving the gas delivery 1208 and gas recovery 1210, areas of the substrate S surface may be approached from different angles which may help in the preparation process. In some cases, purge gas delivered from the gas delivery 1208 may be pulsed, jetted intermittently, jetted more forcefully, or otherwise varied so as to facilitate the removal of contaminants and/or solvent from the surface of the substrate S.

In the specific example of FIG. 12C or similar embodiments which include multiple gas deliveries 1208 and gas recoveries 1210, a particular pair of gas deliveries 1208 and gas recoveries 1210 may only be in operation when their corresponding head is printing, is about to print, or has recently printed. For example, gas delivery 1208b may deliver a purge gas while no purge gas is delivered by either of gas deliveries 1208 a and c. Print head 1204b may dispense ink to a substrate S; subsequently, gas recovery 1210b may recover the purge gas and/or any contaminants without turning on gas recoveries 1210 a and c.

While the present invention has been described primarily with reference to inkjet printing of color filters, it will be understood that the invention also may be employed with other materials and applications. For example, the present invention may also be applied to spacer formation, polarizer coating, and nanoparticle circuit forming.

Accordingly, while the present invention has been disclosed in connection with specific embodiments thereof, it should be understood that other embodiments may fall within the spirit and scope of the invention.

1. An inkjet printing apparatus comprising:
at least one inkjet print head adapted to dispense fluids onto a substrate; and,
at least one delivery aperture adapted to direct a gas toward the substrate.

2. The apparatus of claim 1 further comprising at least one recovery aperture adapted to draw materials away from the substrate and evaporate liquids from the surface of the substrate.

3. The apparatus of claim 1 further comprising a gas supply adapted to pass a gas to the at least one delivery aperture.

4. The apparatus of claim 2 further comprising a vacuum adapted to draw materials away from the substrate through the at least one recovery aperture.

5. The apparatus of claim 3 wherein the gas is nitrogen.

6. The apparatus of claim 3 wherein the gas is fresh air.

7. The apparatus of claim 3 wherein the gas is saturated with a solvent vapor.

8. The apparatus of claim 2 wherein the delivery and recovery apertures are coupled to the inkjet print head.

9. The apparatus of claim 2 wherein each of the at least one inkjet print heads has a corresponding delivery aperture and a corresponding recovery aperture.

10. The apparatus of claim 2 wherein the at least one delivery and recovery apertures are arranged adjacent each other and are further arranged such that a first delivery aperture directs the gas toward the substrate while a first recovery aperture draws materials away from the substrate during inkjet printing in a first print direction and a second delivery aperture directs the gas toward the substrate while a second recovery aperture draws materials away from the substrate during inkjet printing in a second print direction.

11. The apparatus of claim 1 wherein the at least one delivery apertures are further adapted to draw materials away from the substrate and evaporate liquids from the surface of the substrate.

12. The apparatus of claim 2 wherein the at least one recovery apertures are further adapted to direct a gas toward the substrate.

13. An inkjet printing apparatus comprising:
one or more inkjet print heads adapted to dispense fluids onto a substrate;
a print bridge adapted to support the one or more inkjet print heads; and,
at least one delivery aperture coupled to the print bridge adjacent the one or more inkjet print heads and adapted to direct a gas toward the substrate.

14. The apparatus of claim 13 further comprising at least one recovery aperture coupled to the print bridge adjacent the one or more inkjet print heads and adapted to draw materials away from the substrate and evaporate liquids from a surface of the substrate.

15. The inkjet printing apparatus of claim 13 further comprising:
a solvent tank containing solvent;
a gas supply containing a purge gas; and,
a bubbler adapted to receive solvent from the solvent tank and purge gas from the gas supply, mix the solvent and the purge gas, and direct the mixture to the at least one delivery aperture.

16. The apparatus of claim 14 further comprising a vacuum adapted to draw materials away from the substrate through the at least one recovery aperture.

17. The apparatus of claim 15 wherein the purge gas is nitrogen.

18. The apparatus of claim 15 wherein the purge gas is fresh air.

19. The apparatus of claim 14 wherein each of the at least one inkjet print heads has a corresponding delivery aperture and a corresponding recovery aperture.

20. The apparatus of claim 14 wherein the at least one delivery and recovery apertures are arranged adjacent each other and are further arranged such that a first delivery aperture directs the gas toward the substrate while a first recovery aperture draws materials away from the substrate during inkjet printing in a first print direction and a second delivery aperture directs the gas toward the substrate while a second recovery aperture draws materials away from the substrate during inkjet printing in a second print direction.

21. The apparatus of claim 13 wherein the at least one delivery apertures are further adapted to draw materials away from the substrate and evaporate liquids from the surface of the substrate.

22. The apparatus of claim 14 wherein the at least one recovery apertures are further adapted to direct a gas toward the substrate.

23. A method of preparing a substrate for inkjet printing comprising directing a gas toward the substrate through at least one delivery aperture.

24. The method of claim 23 further comprising drawing materials away from the substrate through at least one recovery aperture.

25. The method of claim 23 further comprising passing a gas to the at least one delivery aperture from a gas supply.

26. The method of claim 24 further comprising drawing materials away from the substrate through the at least one recovery aperture using a vacuum.

27. The method of claim 23 wherein the gas is saturated with a solvent vapor.

28. The method of claim 24 further comprising:
directing the gas toward the substrate through a first delivery aperture while a first recovery aperture draws materials away from the substrate during inkjet printing in a first print direction; and,
directing the gas toward the substrate through a second delivery aperture while a second recovery aperture draws materials away from the substrate during inkjet printing in a second print direction.

29. The method of claim 23 further comprising drawing materials away from the substrate through at least one delivery aperture.

30. The method of claim 24 further comprising directing a gas toward the substrate through at least one recovery aperture.

31. A method of inkjet printing comprising:
directing a gas toward a substrate through at least one first aperture coupled to a print bridge; and,
jetting ink onto a substrate via one or more inkjet print heads arranged along a print bridge adjacent the at least one first aperture.

32. The method of claim 31 further comprising drawing materials away from the substrate and evaporating liquids from a surface of the substrate through at least one recovery aperture coupled to the print bridge adjacent the one or more inkjet print heads.

33. The method of claim 31 further comprising:
providing a solvent tank containing solvent;
providing a gas supply containing a purge gas; and,
receiving solvent from the solvent tank and purge gas from the gas supply at a bubbler, mixing the solvent and the purge gas in the bubbler, and directing the mixture to the at least one delivery aperture.

34. The method of claim 32 further comprising drawing materials away from the substrate through the at least one recovery aperture using a vacuum.

35. The method of claim 33 wherein the purge gas is nitrogen.

36. The method of claim 33 wherein the purge gas is fresh air.

37. The method of claim 32 further comprising:
directing the gas toward the substrate through a first delivery aperture while a first recovery aperture draws materials away from the substrate during inkjet printing in a first print direction; and,
directing the gas toward the substrate through a second delivery aperture while a second recovery aperture draws materials away from the substrate during inkjet printing in a second print direction.

38. The method of claim 31 further comprising drawing materials away from the substrate through at least one delivery aperture.

39. The method of claim 32 further comprising directing a gas toward the substrate through at least one recovery aperture.

40. A method comprising:
applying a purge gas to a substrate to uniformly distribute solvent on the substrate; and
depositing ink via inkjets on the substrate.

41. The method of claim 40 further comprising:
applying vacuum pressure to the substrate to recover the purge gas.

42. The method of claim 40 wherein applying a purge gas includes applying a purge gas including solvent vapor.

43. The method of claim 40 wherein applying a purge gas includes applying the purge gas to evaporate any solvent on the substrate.
